(19) United States
(12) Patent Application Publication
(10) Pub. No.: US 2006/0020929 A1
(43) Pub. Date: Jan. 26, 2006

(54) METHOD AND APPARATUS FOR BLOCK MATCHING

(76) Inventor: Kun Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,013

(22) Filed: Jul. 19, 2005

(30) Foreign Application Priority Data
Jul. 20, 2004 (TW) 093121612

(51) Int. Cl. G06F 9/45

(52) U.S. Cl. 717/136; 345/418

(57) ABSTRACT

A block matching device includes a plurality of computing modules, each for respectively computing pixel differences between a plurality of target pixels of a target block and a plurality of reference pixels of a reference block, wherein each computing module has a plurality of processing elements, each processing element for calculating pixel difference between one of the target pixels and one of the reference pixels; and a plurality of adding units respectively coupled to the computing modules, each adding unit for adding the calculated results generated by the processing elements coupled to said adding unit.

### BACKGROUND OF THE INVENTION

1. Field of the Invention

The present invention relates to a block matching method and apparatus thereof, and more particularly, to a method and an apparatus for computing pixel differences between blocks.

2. Description of the Prior Art

Block matching algorithms are widely utilized in many image-processing applications such as the motion estimation process described by the MPEG2/MPEG4 standards. For example, a target block of a current picture is encoded according to a difference between the target block and a most similar block of a preceding picture or a succeeding picture. The most similar block is also called as a reference block. Generally, the block matching operation is done by comparing the target block with all of the similar blocks within a searching area of the preceding picture or the succeeding picture, so as to determine the reference block.

The size of the target block varies with different image processing standards, which may be one of the following sizes: 8×8, 8×16, 16×8, and 16×16, etc. In the prior arts, target blocks with different sizes require different circuits for performing the block matching operation. Consequently, it may be expensive and complicated to implement these circuits.

### SUMMARY OF THE INVENTION

It is therefore an objective of the present invention to provide a block matching apparatus and method thereof capable of processing target blocks of different sizes.

According to an exemplary embodiment of the present invention, a block matching device comprises: a plurality of computing modules for respectively computing pixel differences between a plurality of target pixels and a plurality of reference pixels, wherein each computing module comprises a plurality of processing elements and each of them is used for calculating pixel difference between one of the target pixels and one of the reference pixels; and a plurality of adding units respectively coupled to the computing modules, each adding unit for adding the calculated results generated by the processing elements coupled to said adding unit.

An exemplary embodiment of a block matching device for computing a difference between a target block and a first reference block and a difference between the target block and a second reference block is disclosed. The target block comprises a first pixel and a second pixel, the first reference block comprises a first reference pixel and a second reference pixel, and the second reference block comprises the second reference pixel and a third reference pixel. The block matching device comprises: a first processing element for computing a difference between the first pixel and the first reference pixel; a second processing element for computing a difference between the first pixel and the second reference pixel; a third processing element for computing a difference between the second pixel and the second reference pixel; a fourth processing element for computing a difference between the second pixel and the third reference pixel; a first adding unit for adding the computed results generated by the first and third processing elements; and a second adding unit for adding the computed results generated by the second and fourth processing elements.

According to an exemplary embodiment of the present invention, a block matching method for computing a difference between a target block and a first reference block and a difference between the target block and a second reference block is disclosed. The target block comprises a first pixel and a second pixel, the first reference block comprises a first reference pixel and a second reference pixel, and the second reference block comprises the second reference pixel and a third reference pixel. The method comprises: (a) computing a difference between the first pixel and the first reference pixel; (b) computing a difference between the first pixel and the second reference pixel; (c) computing a difference between the second pixel and the second reference pixel; (d) computing a difference between the second pixel and the third reference pixel; (e) adding the computed results obtained in steps (a) and (c); and (f) adding the computed results obtained in steps (b) and (d).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a target picture according to the present invention.

FIG. 2 is a schematic diagram of a reference picture according to the present invention.

FIG. 3 is a schematic diagram of a block matching device according to an exemplary embodiment of the present invention.

FIG. 4 shows a data flow of the block matching device of FIG. 3 when performing a block matching operation for an 8×8 pixel sized target block according to one embodiment of the present invention.

FIG. 5 is a schematic diagram of a 16×8 pixel sized target block.

FIG. 6 shows a data flow of the block matching device of FIG. 3 when performing a block matching operation for a 16×8 pixel sized target block according to one embodiment of the present invention.

FIG. 7 is a schematic diagram of a 16×6 pixel sized target block.

FIG. 8 shows a data flow of the block matching device of FIG. 3 when performing a block matching operation for a 16×6 pixel sized target block according to one embodiment of the present invention.

### DETAILED DESCRIPTION

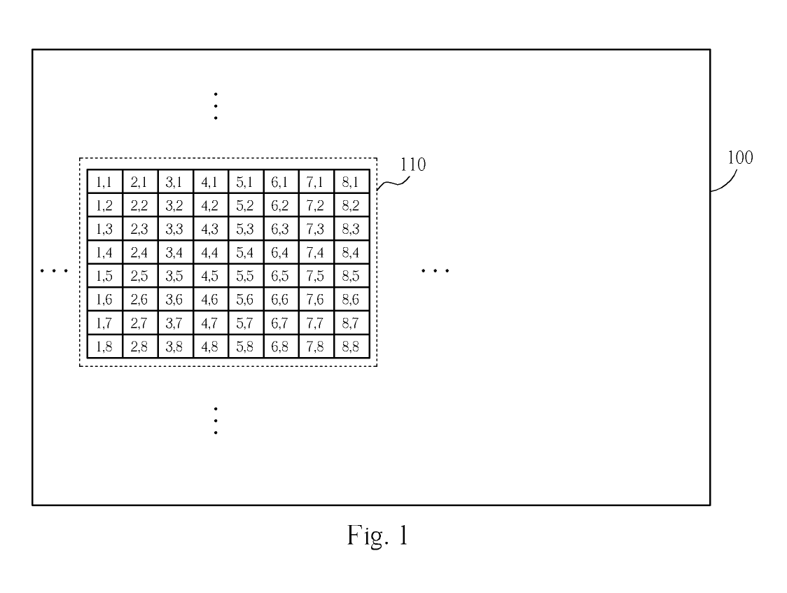

Please refer to FIG. 1, which shows a schematic diagram of a target picture 100 according to the present invention. The target picture 100 comprises an 8×8 pixel sized target block 110. For convenient description, each pixel of the target block 110 is labeled with a corresponding coordinate. In the following elaboration, each pixel of the target block 110 is expressed as C(x,y), where (x,y) is the coordinate of the pixel.

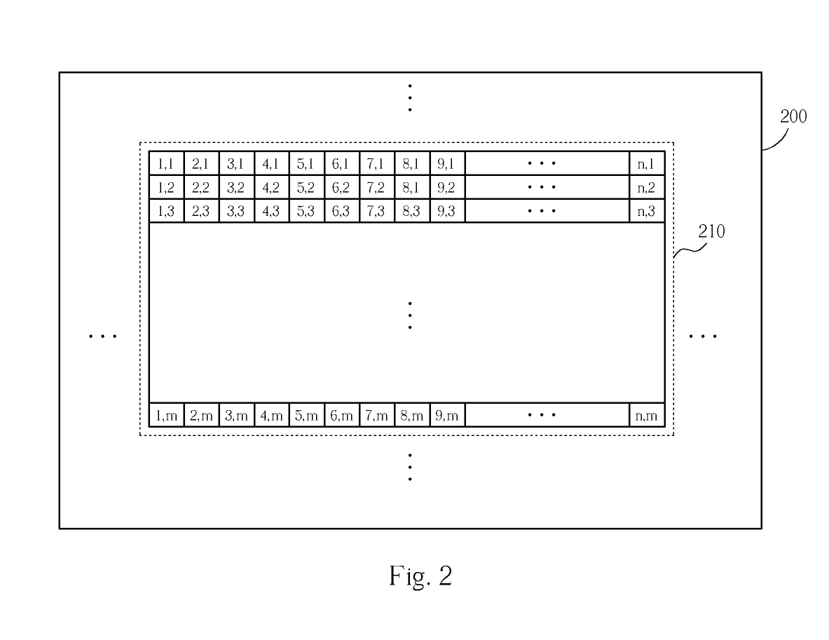

FIG. 2 shows a schematic diagram of a reference picture 200 according to the present invention. Typically, the reference picture 200 is the preceding picture or the succeeding picture of the target picture 100, however, this is not a constraint of the present invention. The reference picture 200 comprises an n by m pixel sized search area 210. In the following elaboration, each pixel of the search area 210 is expressed as R(x,y), where (x,y) is the coordinate of the pixel.

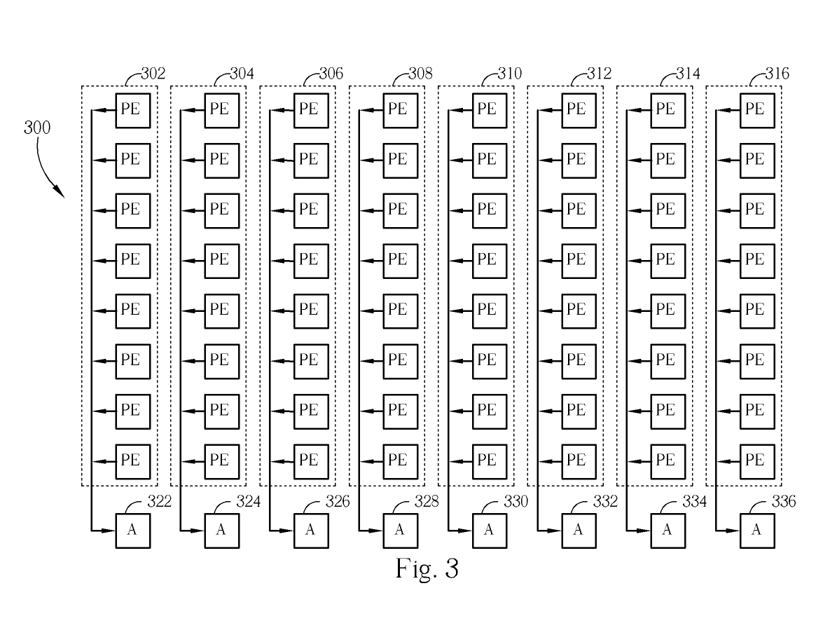

FIG. 3 is a schematic diagram of a block matching device 300 according to an exemplary embodiment of the present invention. The block matching device 300 comprises eight computing modules 302˜316 and eight adding units 322˜336. Each computing module comprises eight processing elements (PE) and each of them is for computing a difference between a pixel of the target block 110 and a pixel of the search area 210. In this embodiment, each PE is utilized for computing an absolute difference (AD) between the two pixels. As shown in FIG. 3, all processing elements of a same computing module are coupled to a corresponding adding unit. In this embodiment, each adding unit is utilized for adding the computed results generated by all the processing elements disposed within a corresponding computing module. In addition, each adding unit of this embodiment is also utilized for accumulating the computed results generated by the corresponding computing module within one ore more computing cycles.

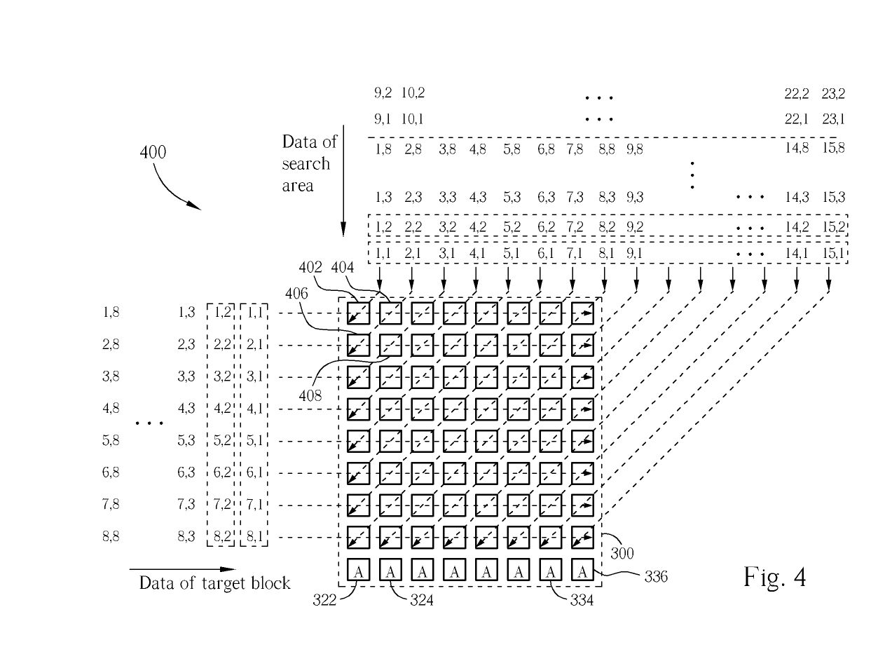

FIG. 4 illustrates a data flow 400 of the block matching device 300 when comparing the target block 110 with a plurality of reference blocks within the search area 210 of the reference picture 200 according to one embodiment of the present invention. For convenient descriptions, each reference block within the search area 210 is represented by a coordinate of the left-top pixel thereof. For example, the left-top reference block within the search area 210 is represented as a reference block RB_{8×8}(1,1) while another reference block, which is rightward shifted one pixel from the reference block RB_{8×8}(1,1), is represented as a reference block RB_{8×8}(2,1) and so forth. Additionally, in order to reduce the complexity of the drawing, the block matching device 300 are simplified by not showing its internal connections in FIG. 4.

In FIG. 4, eight horizontal dotted lines passing through the block matching device 300 represent the data flows of eight pixels on a same row of the target block 110 while fifteen oblique dotted lines passing through the block matching device 300 represent the data flows of fifteen pixels on a same row of the search area 210. It should be noted that in this embodiment, each pixel data is synchronously input to all the processing elements located on a corresponding dotted line (i.e., the pixel data is transmitted to the processing elements in a same computing cycle). Accordingly, there is no delay while loading pixel data into the block matching device 300.

In a first computing cycle, each of the pixels on the first row of the target block 110 (i.e., the pixels C(1,1), C(2,1), . . . , C(7,1), and C(8,1)) is synchronously input to the processing elements on a corresponding horizontal dotted line. For example, in the first computing cycle, the pixel C(1,1) is synchronously input to the eight processing elements, including the PEs 402 and 404, of the first row of the block matching device while the pixel C(2,1) is synchronously input to the eight processing elements, including the PEs 406 and 408, of the second row of the block matching device and so forth. Simultaneously, each of the first fifteen pixels on the first row of the search area 210 (i.e., the pixels R(1,1), R(2,1), . . . R(14,1), and R(15,1)) is synchronously input to the processing elements on a corresponding oblique dotted line. For example, in the first computing cycle, the pixel R(1,1) is synchronously input to the processing element 402 while the pixel R(2,1) is synchronously input to the processing elements 404 and 406 and so forth.

In the second computing cycle, each of the pixels on the second row of the target block 110 (i.e., the pixels C(1,2), C(2,2), . . . , C(7,2), and C(8,2)) is synchronously input to the processing elements on the corresponding horizontal dotted line. Simultaneously, each of the first fifteen pixels on the second row of the search area 210 (i.e., the pixels R(1,2), R(2,2), . . . , R(14,2), and R(15,2)) is synchronously input to the processing elements on the corresponding oblique dotted line. Thus, in the eighth computing cycle, each of the pixels on the eighth row of the target block 110 (i.e., the pixels C(1,8), C(2,8), . . . , C(7,8), and C(8,8)) is synchronously input to the processing elements on the corresponding horizontal dotted line while each of the first fifteen pixels on the eighth row of the search area 210 (i.e., the pixels R(1,8), R(2,8), . . . , R(14,8), and R(15,8)) is synchronously input to the processing elements on the corresponding oblique dotted line.

In respective computing cycles, each processing element synchronously computes an absolute difference (AD) between the two loaded (i.e., inputted) pixels. For example, in the first computing cycle, the processing element 402 of the computing module 302 computes an absolute difference between the pixel C(1,1) and the pixel R(1,1) while the processing element 406 computes an absolute difference between the pixel C(2,1) and the pixel R(2,1). Simultaneously, the processing element 404 of the computing module 304 computes an absolute difference between the pixel C(1,1) and the pixel R(2,1) while the processing element 408 computes an absolute difference between the pixel C(2,1) and the pixel R(3,1). In the second computing cycle, the processing element 402 computes an absolute difference between the pixel C(1,2) and the pixel R(1,2); the processing element 406 computes an absolute difference between the pixel C(2,2) and the pixel R(2,2); the processing element 404 computes an absolute difference between the pixel C(1,2) and the pixel R(2,2); and the processing element 408 computes an absolute difference between the pixel C(2,2) and the pixel R(3,2). Thus, in the eighth computing cycle, the processing element 402 computes an absolute difference between the pixel C(1,8) and the pixel R(1,8); the processing element 406 computes an absolute difference between the pixel C(2,8) and the pixel R(2,8); the processing element 404 computes an absolute difference between the pixel C(1,8) and the pixel R(2,8); and the processing element 408 computes an absolute difference between the pixel C(2,8) and the pixel R(3,8).

As can be inferred from the aforementioned descriptions, a sum of the computed results of the eight processing elements of the computing module 302 obtained in the first computing cycle can be expressed as:

$${\sum }_{x = 1}^{8} \vert C ( x , 1 ) - R ( x , 1 ) \vert$$

and a sum of the computed results of the eight processing elements of the computing module 302 obtained in the second computing cycle can be expressed as:

$${\sum }_{x = 1}^{8} \vert C ( x , 2 ) - R ( x , 2 ) \vert .$$

In this way, a sum of the computed results of the eight processing elements of the computing module 302 obtained in the eighth computing cycle can be expressed as:

$${\sum }_{x = 1}^{8} \vert C ( x , 8 ) - R ( x , 8 ) \vert .$$

In other words, the computed results of the computing module 302 from the first computing cycle through the eighth computing cycle accumulated by the adding unit 322 can be expressed as:

$${\sum }_{y = 1}^{8} {\sum }_{x = 1}^{8} \vert C ( x , y ) - R ( x , y ) \vert$$

Those of ordinary skill in the art can appreciate that the value of the formula (1) is a sum of absolute differences (SAD) between the target block 110 and the left-top reference block RB_{8×8}(1,1) within the search area 210.

Similarly, a sum of the computed results of the eight processing elements of the computing module 304 obtained in the first computing cycle can be expressed as:

$${\sum }_{x = 1}^{8} \vert C ( x , 1 ) - R ( x + 1 , 1 ) \vert$$

and a sum of the computed results of the eight processing elements of the computing module 304 obtained in the second computing cycle can be expressed as:

$${\sum }_{x = 1}^{8} \vert C ( x , 2 ) - R ( x + 1 , 2 ) \vert .$$

In this way, a sum of the computed results of the eight processing elements of the computing module 304 obtained in the eighth computing cycle can be expressed as:

$${\sum }_{x = 1}^{8} \vert C ( x , 8 ) - R ( x + 1 , 8 ) \vert .$$

In other words, the computed results of the computing module 304 from the first computing cycle through the eighth computing cycle accumulated by the adding unit 324 can be expressed as:

$${\sum }_{y = 1}^{8} {\sum }_{x = 1}^{8} \vert C ( x , y ) - R ( x + 1 , y ) \vert$$

The value of the formula (2) is a SAD between the target block 110 and the reference block RB_{8×8}(2,1) within the search area 210.

Thus, the computed results of the computing module 316 from the first computing cycle through the eighth computing cycle accumulated by the adding unit 336 can be expressed as:

$${\sum }_{y = 1}^{8} {\sum }_{x = 1}^{8} \vert C ( x , y ) - R ( x + 7 , y ) \vert$$

The value of the formula (3) is a SAD between the target block 110 and the reference block RB_{8×8}(8,1) within the search area 210.

Accordingly, after the first eight computing cycles, the values accumulated in the eight adding units are respectively the SADs between the target block 110 and the eight reference blocks within the search area 210 (i.e., the reference blocks RB_{8×8}(1,1), RB_{8×8}(2,1), . . . , and RB_{8×8}(8,1).

Finally, in the ninth computing cycle, each of the pixels on the first row of the target block 110 (i.e., the pixels C(1,1), C(2,1), . . . , C(7,1), and C(8,1)) is synchronously input to the processing elements on a corresponding horizontal dotted line. Simultaneously, each of the fifteen pixels starting from the pixel (9,1) on the first row of the search area 210 (i.e., the pixels R(9,1), R(10,1), . . . , R(22,1), and R(23,1)) is synchronously input to the processing elements on a corresponding oblique dotted line. In the tenth computing cycle, each of the pixels on the second row of the target block 110 (i.e., the pixels C(1,2), C(2,2), . . . , C(7,2), and C(8,2)) is synchronously input to the processing elements on a corresponding horizontal dotted line. Simultaneously, each of the fifteen pixels starting from the pixel (9,2) on the second row of the search area 210 (i.e., the pixels R(9,2), R(10,2), . . . , R(22,2), and R(23,2)) is synchronously input to the processing elements on a corresponding oblique dotted line. Thus, after the ninth through sixteenth computing cycles, the values accumulated in the eight adding units are respectively the SADs between the target block 110 and the next eight reference blocks within the search area 210 (i.e., the reference blocks RB_{8×8}(9,1), RB_{8×8}(10,1), . . . , and RB_{8×8}(16,1)).

As mentioned above, the block matching device 300 of this embodiment can compute and obtain eight SADs between the target block 110 and eight reference blocks within the search area 210 every eight computing cycles. In other words, the average time for computing a SAD between the target block 110 and a reference block is only one computing cycle. There is no latency while performing the block matching operation, therefore the computational efficiency of the block matching device 300 is optimized.

In the aforementioned embodiment, the block matching device 300 loads the pixels on a same row of the target block 110 and the pixels on a same row of the search area 210 in a computing cycle to perform the pixel difference computation. This is merely one embodiment and not a constraint of the present invention. In practice, the block matching device 300 could load the pixels on a same column of the target block 110 and the pixels on a same column of the search area 210 in a computing cycle to perform the computation.

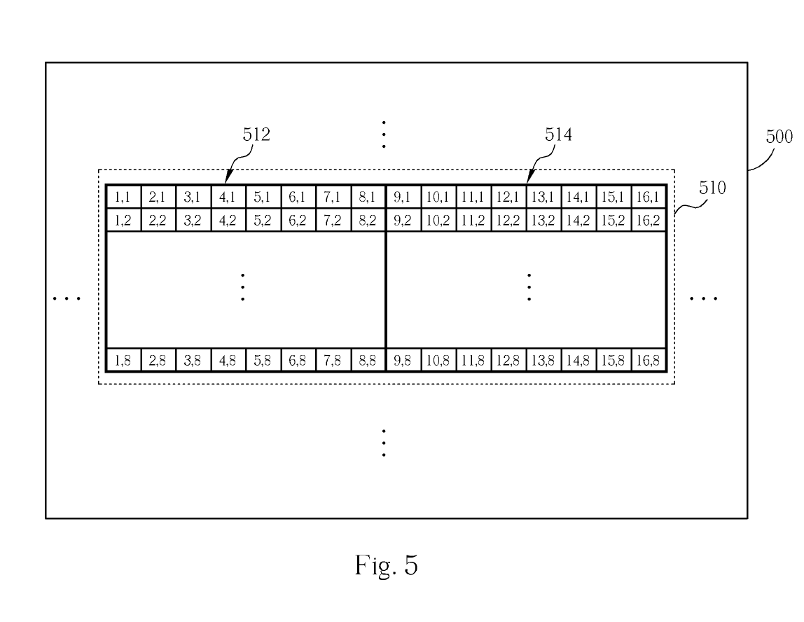

In addition, the block matching device 300 can support the block matching operations for blocks of different sizes. Supposing that the target block is 16×8 pixel sized, as shown in FIG. 5, the block matching device 300 can divide a target block 510 of a target picture 500 shown in FIG. 5 into two 8×8 pixel sized sub-blocks 512 and 514 and then perform block matching operations utilizing the same manner as the aforementioned embodiments.

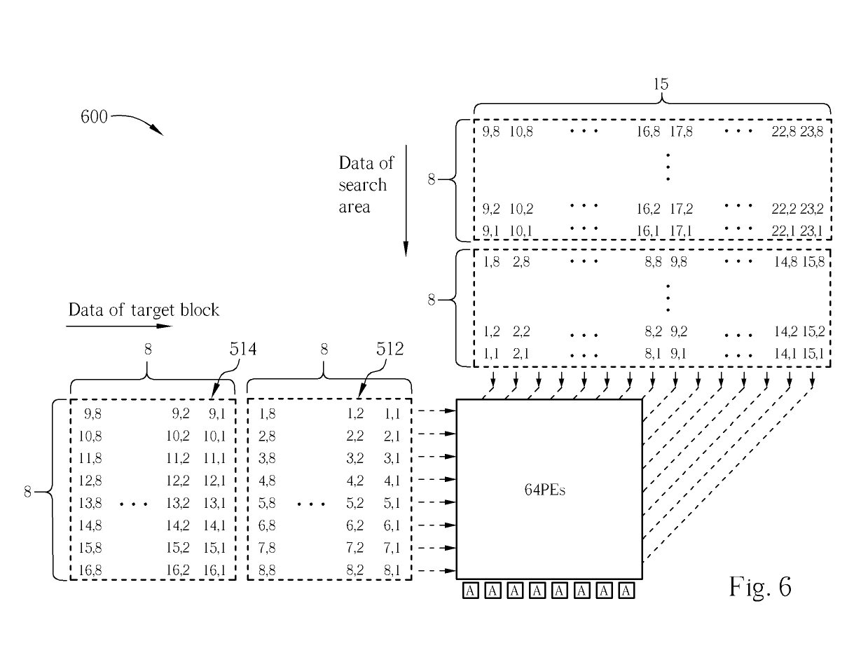

FIG. 6 illustrates a data flow 600 of the block matching device 300 when comparing the target block 510 with a plurality of reference blocks within the search area 210 of the reference picture 200 according to one embodiment of the present invention.

In a first computing cycle, each of the pixels on the first row of the sub-block 512 (i.e., the pixels C(1,1), C(2,1), . . . , C(7,1), and C(8,1)) is synchronously input to the processing elements on a corresponding horizontal dotted line. Simultaneously, each of the first fifteen pixels on the first row of the search area 210 (i.e., the pixels R(1,1), R(2,1), . . . , R(14,1), and R(15,1)) is synchronously input to the processing elements on a corresponding oblique dotted line. In the second computing cycle, each of the pixels on the second row of the sub-block 512 (i.e., the pixels C(1,2), C(2,2), . . . , C(7,2), and C(8,2)) is synchronously input to the processing elements on the corresponding horizontal dotted line. Simultaneously, each of the first fifteen pixels on the second row of the search area 210 (i.e., the pixels R(1,2), R(2,2), . . . , R(14,2), and R(15,2)) is synchronously input to the processing elements on the corresponding oblique dotted line. The operations from the third computing cycle through the eighth computing cycle may be reduced by analogy.

In the eighth computing cycle, each of the pixels on the first row of the sub-block 514 (i.e., the pixels C(9,1), C(10,1), . . . , C(15,1), and C(16,1)) is synchronously input to the processing elements on the corresponding horizontal dotted line while each of the fifteen pixels starting from the pixel (9,1) on the first row of the search area 210 (i.e., the pixels R(9,1), R(10,1), . . . , R(22,1), and R(23,1)) is synchronously input to the processing elements on the corresponding oblique dotted line. In the tenth computing cycle, each of the pixels on the second row of the sub-block 514 (i.e., the pixels C(9,2), C(10,2), . . . , C(15,2), and C(16,2)) is synchronously input to the processing elements on the corresponding horizontal dotted line while each of the fifteen pixels starting from the pixel (9,2) on the second row of the search area 210 (i.e., the pixels R(9,2), R(10,2), . . . , R(22,2), and R(23,2)) is synchronously input to the processing elements on the corresponding oblique dotted line.

Consequently, after the first sixteen computing cycles, the values accumulated in the eight adding units are respectively the SADs between the target block 510 and the eight reference blocks within the search area 210 (i.e., the reference blocks RB_{8×8}(1,1), RB_{8×8}(2,1), . . . and RB_{8×8}(8,1)). In this embodiment, the average time for computing a SAD between the target block 510 and a reference block is only two computing cycles. In practical implementations, the block matching device 300 could load the pixels on a same column of either the sub-block 512 or the sub-block 514 and the pixels on a same column of the search area 210 in a computing cycle to perform the computation.

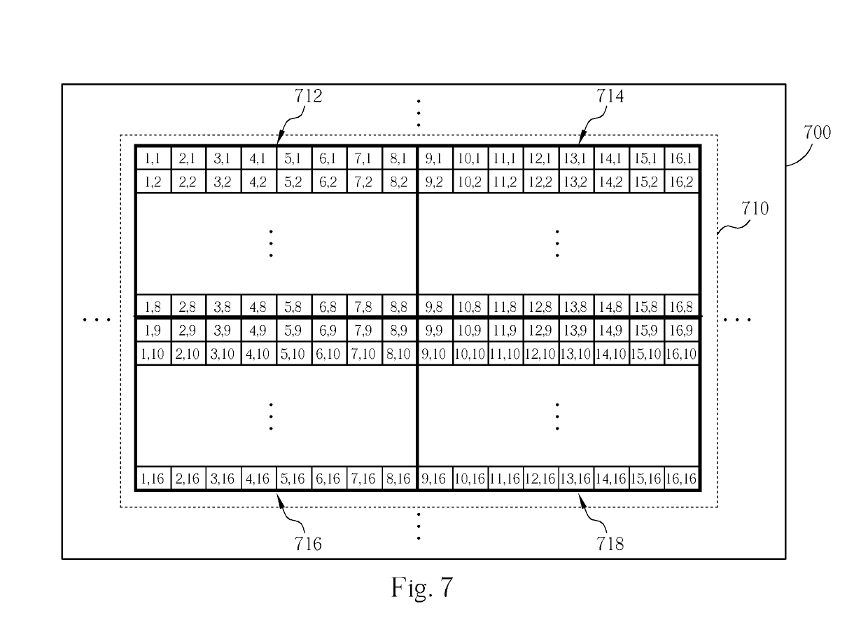

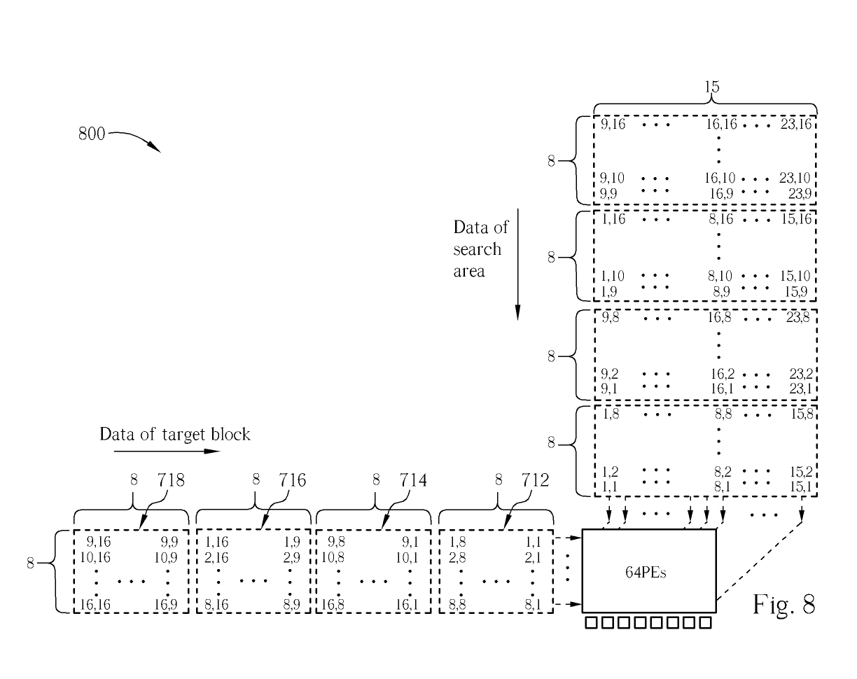

Supposing that the target block is 16×16 pixel sized as shown in FIG. 7, the block matching device 300 can perform block matching operations utilizing the same manner as the aforementioned embodiments by dividing a target block 710 of a target picture 700 shown in FIG. 7 into four 8×8 pixel sized sub-blocks 712, 714, 716, and 718. FIG. 8 illustrates a data flow 800 of the block matching device 300 when comparing the target block 710 with a plurality of reference blocks within the search area 210 of the reference picture 200 according to one embodiment of the present invention. The operations of the block matching device 300 are similar to the aforementioned embodiments; therefore, the details are omitted for brevity.

In this embodiment, after the first thirty two computing cycles, the values accumulated in the eight adding units are respectively the SADs between the target block 710 and the eight reference blocks within the search area 210 (i.e., the reference blocks RB_{8×8}(1,1), RB_{8×8}(2,1), . . . , and RB_{8×8}(8,1)). In other words, the average time for computing a SAD between the target block 710 and a reference block is only four computing cycles. Similarly, the block matching device 300 could load the pixels on a same column of one of the sub-blocks 712, 714, 716, and 718 and the pixels on a same column of the search area 210 in a computing cycle to perform the computation.

As the forgoing illustrates, the block matching device 300 is capable of utilizing the same processing element (PE) array to process target blocks of different sixes such as 8×8, 16×8, 8×16, 16×16, etc. This capability significantly improves the circuitry usage flexibility.

It should be noted that the 8×8 sized PE array of the block matching device 300 is merely an embodiment rather than a limitation of the applications of the present invention. In practice, the above-mentioned block matching operations of different sized target blocks could also be realized by utilizing 4×4 sized PE array or 2×2 sized PE array rather than the 8×8 sized PE array.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A block matching device comprising:
a plurality of computing modules, each for respectively computing pixel differences between a plurality of target pixels of a target block and a plurality of reference pixels of a reference block, wherein each computing module comprises a plurality of processing elements, each processing element for calculating pixel difference between one of the target pixels and one of the reference pixels; and
a plurality of adding units respectively coupled to the computing modules, each adding unit for adding the calculated results generated by the processing elements coupled to said adding unit.

2. The block matching device of claim 1, wherein one of the target pixels is synchronously transmitted to a plurality of first processing elements of the processing elements.

3. The block matching device of claim 2, wherein the plurality of first processing elements respectively correspond to the computing modules.

4. The block matching device of claim 1, wherein one of the reference pixels is synchronously transmitted to a plurality of second processing elements of the processing elements.

5. The block matching device of claim 4, wherein the plurality of second processing elements respectively correspond to the computing modules.

6. The block matching device of claim 1, wherein each of the adding units is for adding the calculated results generated by the corresponding computing module within one or more computing cycles.

7. The block matching device of claim 1, wherein each of the processing elements is for computing an absolute difference between one of the target pixels and one of the reference pixels.

8. The block matching device of claim 1, wherein the target pixels are located in a same row or a same column of the target block.

9. The block matching device of claim 1, wherein the reference pixels are located in a same row or a same column of the reference block.

10. A block matching device for computing a difference between a target block and a first reference block and for computing a difference between the target block and a second reference block, the target block comprising a first pixel and a second pixel, the first reference block comprising a first reference pixel and a second reference pixel, and the second reference block comprising the second reference pixel and a third reference pixel, the block matching device comprising:
a first processing element for computing a difference between the first pixel and the first reference pixel;
a second processing element for computing a difference between the first pixel and the second reference pixel;
a third processing element for computing a difference between the second pixel and the second reference pixel;
a fourth processing element for computing a difference between the second pixel and the third reference pixel;
a first adding unit coupled to the first and third processing elements for adding the computed results of the first and third processing elements; and
a second adding unit coupled to the second and fourth processing elements for adding the computed results of the second and fourth processing elements.

11. The block matching device of claim 10, wherein the second reference pixel is synchronously transmitted to the second and third processing elements.

12. The block matching device of claim 10, wherein the first pixel is synchronously transmitted to the first and second processing elements.

13. The block matching device of claim 10, wherein the second pixel is synchronously transmitted to the third and fourth processing elements.

14. The block matching device of claim 10, wherein each processing element is for computing an absolute difference between pixels.

15. A block matching method for computing a difference between a target block and a first reference block and for computing a difference between the target block and a second reference block, the target block comprising a first pixel and a second pixel, the first reference block comprising a first reference pixel and a second reference pixel, and the second reference block comprising the second reference pixel and a third reference pixel, the method comprising:
computing a first difference between the first pixel and the first reference pixel;
computing a second difference between the first pixel and the second reference pixel;
computing a third difference between the second pixel and the second reference pixel;
computing a fourth difference between the second pixel and the third reference pixel;
adding the computed results generated according to the steps of computing the first and third differences; and
adding the computed results generated according to the steps of computing the second and fourth differences.

16. The method of claim 15, wherein the computing steps are synchronously performed.

17. The method of claim 15, wherein each of the computing steps comprises computing an absolute difference between pixels.

18. A block matching device comprising:
a plurality of computing modules, each for computing pixel differences between a plurality of target pixels and a plurality of reference pixels, wherein each computing module comprises a plurality of processing elements, each processing element calculating pixel difference between one of the target pixels and one of the reference pixels; and
a plurality of adding units respectively coupled to a part of the processing elements, each adding unit adding the calculated results generated by the part of the processing elements.

19. The block matching device of claim 18, wherein one of the target pixels is synchronously transmitted to a part of the processing elements.

20. The block matching device of claim 18, wherein one of the reference pixels is synchronously transmitted to a part of the processing elements.
